(19) United States
(12) Patent Application Publication
(10) Pub. No.: US 2004/0145729 A1
(43) Pub. Date: Jul. 29, 2004

(54) Method and device for testing sunglasses

(76) Inventor: Tzvika Verfel, Givat Yav (IL)

Correspondence Address: DR. MARK FRIEDMAN LTD., C/o Bill Polkinghorn, Discovery Dispatch, 9003 Florin Way, Upper Marlboro, MD, 20772, US

(21) Appl. No.: 10/350,041

(22) Filed: Jan. 24, 2003

(51) Int. Cl. G01B 9/00

(52) U.S. Cl. 356/124

(57) ABSTRACT

A device for testing sunglasses is disclosed, including an image to be viewed having a light source configured to project light in a direction from which the image is viewed, the projected light being chosen so as to simulate specific lighting conditions such as snow, beach or desert lighting conditions. Also, a method for testing sunglasses is disclosed. An image, such as a physical picture is placed in the line of sight of a person wearing a pair of sunglasses. Light simulating specific lighting conditions is projected at the person. By looking at the image while being illuminated, the person can evaluate the efficacy and comfort of the glasses. Also, a method of selling sunglasses is disclosed. A purchaser wears a pair of sunglasses to be purchased while being subjected to lighting conditions simulating conditions where the glasses are to be worn.

### FIELD AND BACKGROUND OF THE INVENTION

The present invention relates to the field of optical devices and specifically to a method and a device for evaluating sunglasses.

Sunglasses are a popular consumer product. A person purchasing sunglasses goes to a store and finds a large number of different pairs sunglasses from which to choose. Important reasons for selecting one pair of sunglasses instead of another include comfort, styling and fashion. The purchaser describes the desired style requirements and the seller presents the various options that meet the requirements as well as similar variants. The purchaser then tries on a number of the glasses in order to choose which pair gives the face a desired appearance, gives the wearer a desired image and is also comfortable to wear.

The disadvantage with the described process is that the sunglasses are purchased without “optical comfort” being determined. By optical comfort is meant the combined effects of field of view covered by the glasses and the optical properties of the lens such as lens color, filtering ability and glare reduction. Trying the sunglasses on in a store is useless as indoors illumination is of low intensity and of a spectrum different then that of sunlight. Often a purchaser asks to take a pair of sunglasses outside. This is not an ideal solution: it is difficult to take many pairs outside to test and the process of trying the sunglasses outside is time consuming. Most critically, testing the sunglasses in such a way is inappropriate. Testing sunglasses in the New York afternoon light indicates little of the comfort and suitability of the glasses for the ski slopes of Aspen, the beaches of the Bahamas or on the deck of the Queen Elizabeth II.

U.S. Pat. No. 6,113,238 teaches of a device for demonstrating glare reduction by polarizing sunglasses in order to convince persons to purchase glasses having polarizing lenses. Not taught is a method or a device for evaluating the efficacy of various sunglasses.

It would be highly advantageous to have a method that allows testing sunglasses under conditions that allow a person to know if the sunglasses will be useful under actual conditions. It would be advantageous for a retailer of sunglasses to be able to allow a purchaser to test sunglasses in actual conditions before the actual purchase.

### SUMMARY OF THE INVENTION

The above and other objectives are achieved by the methods and device of the present invention.

According to the teachings of the present invention there is provided a method of testing glasses comprising

a. having a person view an image while wearing the glasses;

b. projecting light at the eyes of the person wearing the glasses; and

c. having the person evaluate the efficacy of the glasses.

Although the projection of the light into the eyes of a person makes viewing the at least one image difficult, as the person is wearing glasses the difficulty is at least partially alleviated. Using the method of the present invention, the person can evaluate how effective a given pair of glasses are at alleviating the effect of the light.

According to a feature of the present invention attributes of the light projected at the eyes of the person are chosen so as to simulate specific lighting conditions, such as outdoors, snow, ski slope, ocean, lake, beach, discotheque, dawn, dusk and desert lighting conditions. In such a way a person is able to select a pair of glasses most suitable for the lighting conditions at which the glasses are actually used. Clearly it is preferable that the image viewed corresponds to the specific lighting conditions simulated, for example beach lighting conditions are simulated while viewing an image of a beach complete with palm trees and bikinis or ski slope lighting conditions are simulated while viewing an image of a ski slope complete with trees and ski lifts

According to a feature of the present invention, during the sunglass evaluation process the attributes of the projected light are varied, for example to simulate different lighting conditions. In such a way a person is exposed to, in succession, simulations of various lighting conditions so as to effectively evaluate a pair of glasses.

According to a feature of the present invention, attributes of light that are used to simulate light conditions and that can be varied include at least one of the attributes from a group consisting of spectrum, intensity, polarization, glare, diffusness and symmetry.

There is also provided according to the teachings of the present invention a device for testing glasses comprising an enclosure with an image-displaying device positioned therein, a view port in the enclosure through which an image displayed on the image-displaying device can be viewed and a light source configured to project light in the direction of the view port. The enclosure is so configured that the eyes of a person viewing the image through the view port are illuminated substantially only with light from the light source and from the image. Clearly the device is useful in implementing the method of the present invention as described hereinabove.

According to a feature of the present invention the light source is not symmetrical, that is to say, the attributes of light coming from one area of the light source are substantially different from attributes of light coming from other areas of the light source. For example, as discussed below, attributes of light produced by the light source to simulate sky are different from attributes of light produced by the light source to simulate ground.

According to a feature of the present invention the light source is a variable light source, that is the light source includes controlling means such as control mechanisms, individual lamps, filters, power supplies, irises, glare producing devices and the like allowing the attributes (such as spectrum, intensity, polarization, glare, diffuseness and symmetry) of the light produced by the light source to be varied. According to a further feature of the present invention the device of the present invention includes a control unit, preferably a computerized control unit, to control the attributes of the light produced by the variable light source, generally by controlling the controlling means. For example, an operator of the device can select to simulate “beach lighting” and the control unit adjusts the control mechanisms, power supplies, filters and individual lamps making up the light source of the device to simulate the lighting conditions of a typical beach situation.

According to a feature of the present invention the image-displaying device is a physical object such as a photograph or a print which inherently integrates the viewed image. According to a different feature of the present invention the image-displaying device is one that generates a non-physical image, such as a projector screen, a cathode ray tube, plasma screen display or the like. According to a feature of the device of the present invention, the image is changeable, preferably upon command, for example using the control unit described above. Such a feature allows an image of a beachfront to be changed to an image of a ski slope when desired.

For maximum utility in evaluating a pair of sunglasses, the light conditions must be as accurate a simulation as possible. According to a feature of the present invention the light produced by the light source illuminate the eyes of a person viewing the image through the view port from a plurality of directions. Preferably the light source is configured so as to illuminate the eyes of a person viewing the image through the view port from a horizontal arc greater than about 90°, more preferably greater than about 120°, and even more preferably greater than 135°. Preferably the light source is configured so as to illuminate the eyes of a person viewing the image through the view port from a vertical arc greater than about 90°, more preferably greater than about 100°, and even more preferably greater than 120°.

It is most preferable that the light source is configured so as to illuminate the entire field of view of a person viewing the image through the view port. The human field of view spans approximately 2000 horizontally and 135° vertically. Thus according to a feature of the present invention, the light source is configured so as to illuminate the eyes of a person viewing the image through the view port with a vertical arc greater than about 1300 and even more preferably greater than about 135° and with a horizontal arc greater than about 180° and even more preferably greater than about 200°. In such a way, light simulating the desired lighting conditions is projected at the complete field of view of a person whose eyes are situated at the view port allowing an excellent evaluation of a pair of sunglasses.

There is also provided according to the teachings of the present invention a method selling glasses comprising having a purchaser wear a pair of glasses to be purchased and then evaluating the pair of glasses (for and by the purchaser) under at least one condition of lighting, by projecting light at the purchaser, the light projected simulating the at least one lighting condition. The lighting condition simulated includes, for example, outdoor, snow, ski slope, ocean, lake, beach, discotheque, dawn, dusk and desert lighting conditions.

### BRIEF DESCRIPTION OF THE DRAWINGS

The invention is herein described, by way of example only, with reference to the accompanying drawings, wherein:

FIG. 1A is a schematic depiction of a device of the present invention;

FIG. 1B is schematic depictions of a device of the present invention from the top in cross section;

FIG. 1C is schematic depictions of a device of the present invention from the side in cross section; and

FIGS. 2A and 2B are schematic depictions of fields of illumination of a device of the present invention.

### DETAILED DESCRIPTION OF THE INVENTION

The present invention is of a method and a device for the evaluation of glasses and also for a method of selling glasses. The core of the invention is that a person wearing a pair of glasses views an image while light simulating a specific lighting situation is projected towards the eyes of the person. The person can then evaluate how useful the specific set of glasses is for neutralizing the interfering effect of light in the specific lighting situation. The principles and use of the present invention are better understood with reference to the drawings and description hereinbelow.

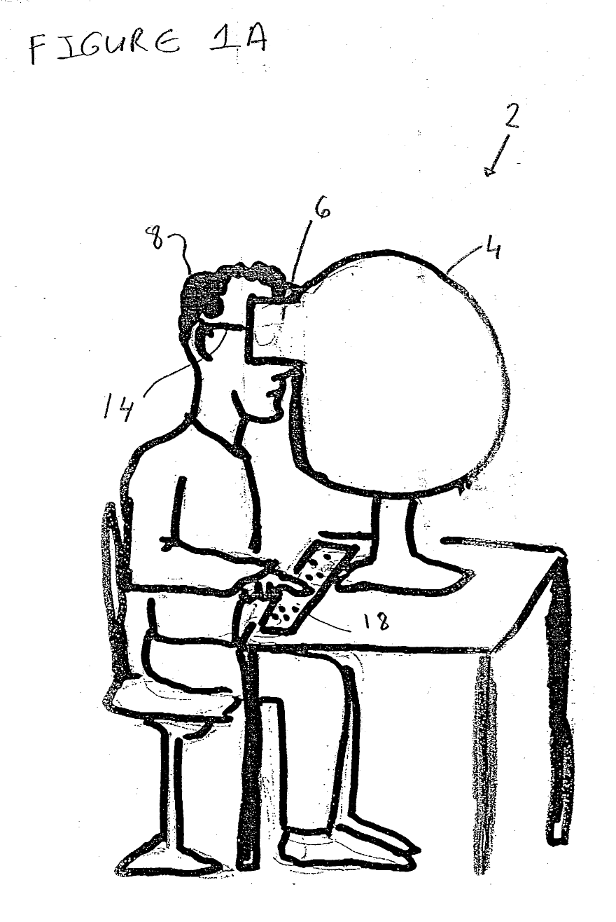

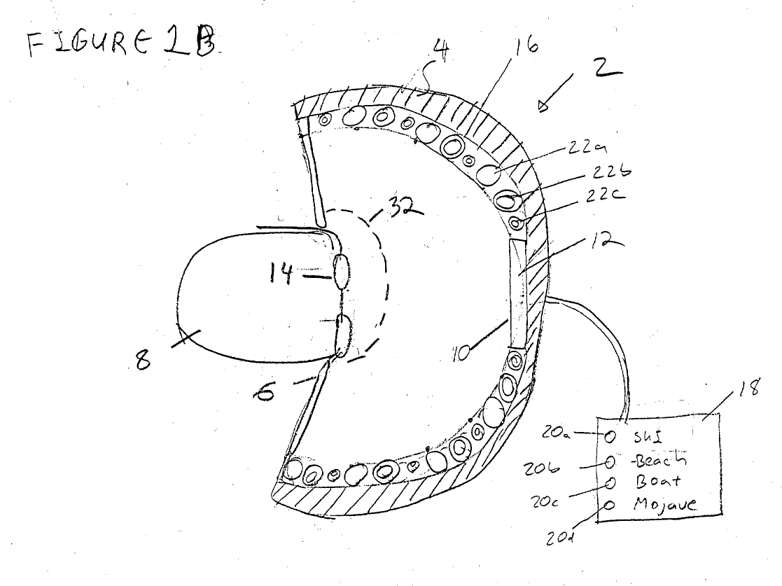

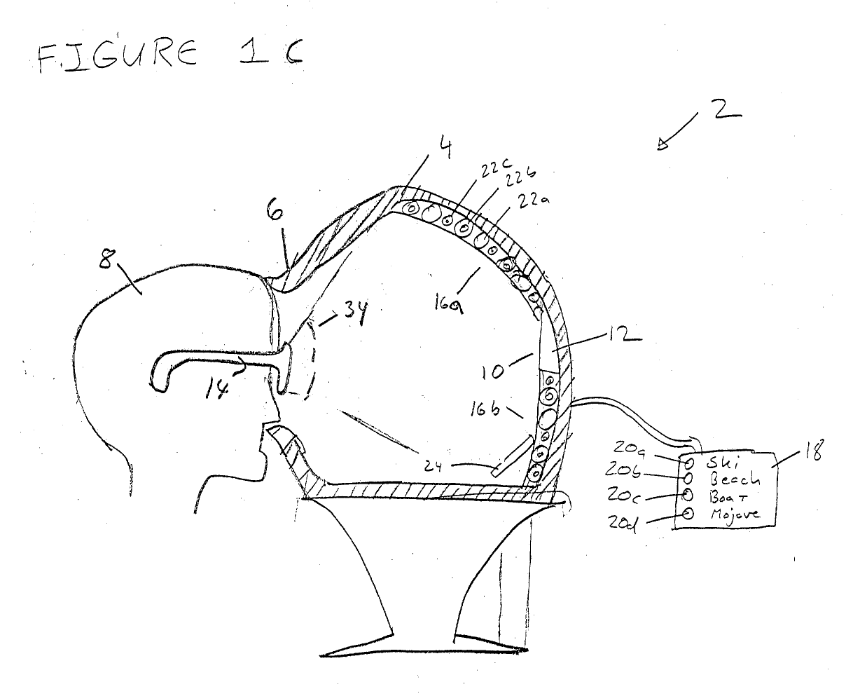

An embodiment of the device of the present invention 2 is schematically depicted in FIG. 1. Device 2 includes an enclosure 4 with a view port 6. Device 2 is configured so that a person 8 can look comfortably look through view port 6 into enclosure 4 at an image 10 on a display screen 12 (a flat plasma screen) while wearing glasses 14.

The size of a device of the present invention, such as device 2, is preferably such that the device can rest on a table or the like. Thus although any size of device sufficient to perform all the required functions is possible, it is preferable that the height, width and depth of the present invention each is independently of between about 20 cm and about 60 cm.

In order that the lighting situation simulated by a device of the present invention be most accurate it is preferred that no light excepting that coming from screen 12 or light source 16 reaches the eyes of person 8. It is thus preferred that enclosure 4 and view port 6 be constructed in such a way so that person 8 looking through view port 6 at image 10 sees substantially no light except that coming from image 10 or light source 16. Device 2 is fitted with a flat plasma screen 4 to display an image 10 to person 8 using device 2.

It is preferred that a device of the present invention, such as 2, be configured to display one image 10 at a time from a plurality of possible images, and that the user can select which image is displayed at any time. An image in a device of the present invention can be a physical image such as a print, a photograph or the like. Preferably the image of the present invention is an image displayed on a suitable image-displaying device. Suitable image-displaying devices include but are not limited to a screen on which an image is projected from the front (i.e. the side of the person viewing the image) a screen on which an image is projected from the back (i.e. the screen is positioned between the person viewing the image and the projector), a cathode ray tube, a plasma screen or other display technologies. The advantage of using an image-displaying device is that it is a simple matter to select and change an image to be displayed.

A critical part of implementing the present invention is in using light source 16 to produce light that simulates specific lighting conditions. The greater the accuracy of simulation, the better the utility of the device. One skilled in the art recognizes that there are a number of light attributes that can be modified and adjusted to simulate any given light condition.

A first attribute is the spectrum of the projected light. One skilled in the art recognizes that there are many existing light sources such as lamps and the like capable of producing any of the wavelengths and any spectrum of visible and ultraviolet light, being the wavelengths important for the testing of sunglasses. In a preferred embodiment of the present invention, the device comprises a plurality of different individual lamps and the like (e.g. 22a-22c, as depicted in FIG. 1), in some cases equipped with means such as filters and the like to allow a reasonable simulation of a desired spectrum. It is clear to one skilled in the art that it may not be required and may even be disadvantageous to project ultraviolet light at a person testing sunglasses. Thus in a preferred embodiment of the device of the present invention, a light source includes at least one ultraviolet filter to reduce or prevent ultraviolet light from reaching a person using the device.

A second attribute is the intensity of projected light. Methods of varying the intensity of a light source are well known to one skilled in the art, for example by using “gray filters” or varying the power supply to a lamp making up a light source. Thus, a device of the present invention is preferably equipped with mechanical and other means allowing the adjustment of the intensity of light produced.

A third attribute is polarization of projected light. In many situations where sunglasses are used some light is polarized. In order to make an accurate simulation of a given light situation, a light source of the present invention preferably includes polarization means, such as filters, so that the light produced by the light source is at least partially polarized.

A fourth attribute is glare. One of the important uses of sunglasses is in the reduction of glare. In order to make an accurate simulation of a given light situation, a light source of the present invention preferably includes a glare producing means (24 in FIG. 1B) so that light produced by the light source includes glare. Devices and method for the generation of glare have been described in U.S. Pat. No. 4,800,404 and U.S. Pat. No. 6,113,238.

A fifth attribute is diffuseness. Light from the sky is mostly diffuse light. In order to make an accurate simulation of a given light situation, a light source of the present invention preferably is provided with a light diffusion means. Such light diffusion means generally include opaque barriers through which light passes before reaching the eyes of a person using a device of the present invention. It is important to note that many individual lamps, suitable for use in making a light source of the present invention, produce appropriately diffuse light.

A sixth attribute is the sun. On skilled in the art knows that the presence of the sun as an intense and not diffuse source of light in a field of view is a great source of discomfort. It is thus preferred that a light source of device of the present invention be equipped with a sun-simulating means. Clearly a sun simulating means must be of limited intensity and spectrum so as not to damage the eyes of the person using a device of the present invention.

A seventh attribute is symmetry. It is clear to one skilled in the art that natural light conditions are rarely symmetrical. Light from above the horizon is generally sunlight that changes in intensity with proximity to the sun. Significant changes in the spectrum of light from above the horizon are generally apparent only during the dawn and twilight. In contrast, light from the ground is reflected light. Attributes such as glare, spectrum, polarization and intensity are important for simulating reflected light and highly dependent on the composition of the ground, be it asphalt, water, earth, sand or snow. Thus in a preferred embodiment of the present invention, the light produced by the light source of the present invention is not symmetrical, especially not vertically symmetrical: light from the upper area of light source 16a is different then light from the lower area of light source 16b, FIG. 1B.

A seventh attribute important for simulating a given lighting condition is the field of illumination, that is the extent in which the field of view of the person is exposed to light. The greater the part of the field of views of a person that is illuminated, the more accurate the simulation of lighting conditions. In other words, it is preferred that light from the light source be directed at the person from a plurality of directions, rather than substantially from one direction. Preferably the plurality directions are spread over a horizontal arc of at least 90°, more preferably at least 120° and even more preferably greater than 150°. Preferably the plurality directions are spread over a vertical arc of at least 90°, more preferably at least 100° and even more preferably greater than 120°.

Although in some embodiments of the present invention only part of the field of view is illuminated, in a most preferred embodiment the entire field of view of a user is illuminated. The human field of view spans approximately 200° horizontally and 135° vertically. A number of methods can be used to ensure that the entire field of view of a person using a device of the present invention is subject to illumination.

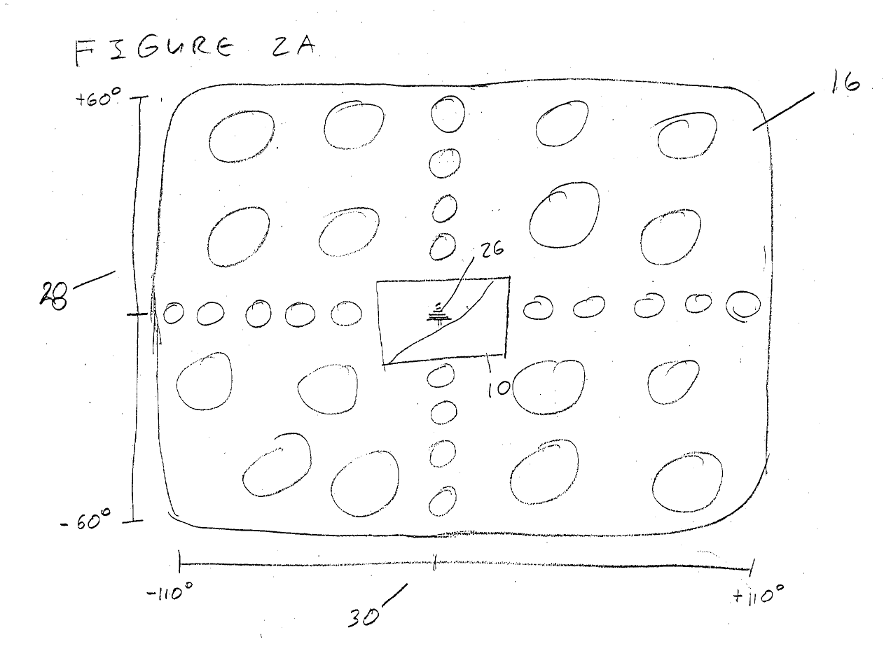

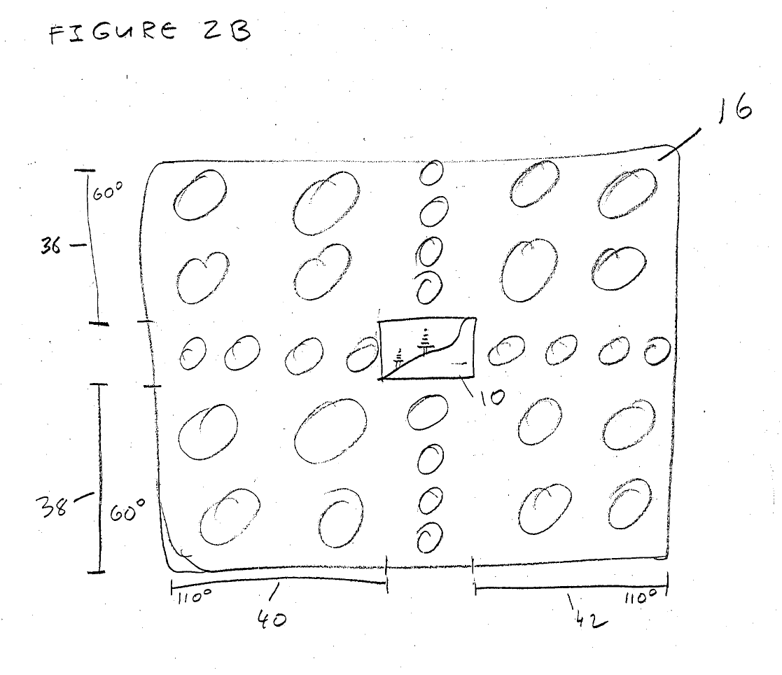

In order to ensure that the field of view of a person is properly illuminated, an image can have a prominent feature located so that the field of view of a person looking at the prominent feature is centered and overlaps the field of illumination. In FIG. 2A, in image 10 depicting a ski slope is a prominent feature 26, a tree. The eyes of a person looking at image 10 are naturally drawn to prominent feature 26. Light source 16 surrounding image 10 has a vertical arc 28 of 120° centered about prominent feature 26 and has a horizontal arc 30 of 220° centered about prominent feature 26.

It is the opinion of the inventor that a light source having a field of illumination having a vertical arc greater than about 120° and having a horizontal arc greater than about 180° is generally sufficient to give an accurate simulation of lighting conditions. More preferable is a light source having a field of illumination with a vertical arc greater than about 135° and with a horizontal arc greater than about 200°. Light source 16 of device 2 is depicted as having a field of illumination with a horizontal arc 32 of 220° (FIG. 1A) and a vertical arc 34 of 120° (FIG. 1B).

Alternatively, in order to ensure that the field of view of a person is properly illuminated, the field of illumination is greater than the field of view to the extent that at whatever point of an image a person looks, the person's entire field of view is illuminated. In FIG. 2B, in image 10 depicting a ski slope of a device of the present invention is schematically depicted. Light source 16 surrounding image 10 has an upper vertical arc 36 of 60° from the top edge of image 10 and a lower vertical arc 38 of 60° from the bottom edge of image 10. Light source 16 surrounding image 10 has a left horizontal arc 40 of 110° from the left edge of image 10 and a right horizontal arc 42 of 110° from the right edge of image 10. As a result, the entire field of view of a person viewing any point of image 10 will be illuminated by light source 16.

It is clearly advantageous that a user of a device of the present invention, whether the seller of the sunglasses or the purchaser of the sunglasses be able to change both the image viewed and the light conditions simulated. In general, it is most advantageous that the image viewed corresponds to the light conditions simulated. For example, on a computer storage device, for example that is part of a control unit, are stored images and instructions to the light source, corresponding to light situations to be simulated by the device. The instructions to the light source include specific settings to each of the elements of the light source, such as filters, polarizing means, glare producing means, individuals lamps, power supplies and the like so as to simulate the selected light condition.

A person uses a control means associated with a device of the present invention to request given light conditions. The instructions and appropriate image are retrieved from the storage device by the control means. The control means then adjusts the image and light source.

Clearly the greater the number of conditions that are simulatable, the greater the utility of a device of the present invention. Typical lighting conditions include outdoor include snow, ski slope, ocean, lake, beach and desert lighting conditions. Also important are indoors conditions such as found in discotheques and equivalents such as dance halls, night clubs and the like, locales where people often where sunglasses. It is also preferable that there be not only location-determined lighting conditions, but also weather dependent lighting conditions such as cloudy. It is also preferable that there be time dependent lighting conditions, especially lighting conditions at dawn and dusk.

In FIG. 1, device 2 is depicted as having a control unit 18. Control unit 18 is a simple to operate computerized device with four preprogrammed lighting conditions available.

When one of four buttons 20 is pressed a corresponding image 10 is displayed on display screen 12 while the attributes of light produced by light source 16 are changed to generate an appropriate simulation of a corresponding lighting condition. An advantage of the present invention is that the lighting conditions can be selected and changed automatically, by the seller or by the purchaser.

For example, when button 20a is pressed, an image of a ski slope is depicted on display screen 12. Further, the attributes of light produced by light source 16 are selected so as to simulate the lighting conditions found at a ski slope. The instructions to light source 16, e.g. what amount of glare is to be produced by glare producing means 24, which and at what intensities the various individual lamps 22a-22c are to be used, what filters are to be in place, whether or not the polarization means are to be activated. and so forth, are stored in computerized control 18 and transferred to light source 16 when necessary.

When button 20b is pressed, an image of a beach is depicted on display screen 12. Further, the attributes of light produced by light source 16 are selected so as to simulate the lighting conditions found on a beach.

A person interested in purchasing a pair of sunglasses goes to a store where a device of the present invention, such as 2, is located. After describing requirements, a store representative gives the person a number of possible sunglasses. The person tries each of the sunglasses on. When so desired, the person looks through view port 6 and selects one of the available lighting conditions using control unit 10. The person can then evaluate how suitable each and every pair of sunglasses is for lighting conditions that may be of interest. In such a way, purchase of sunglasses is performed in a rational manner and based on “optical comfort”.

Selection of the lighting conditions simulated can be done automatically but is preferably performed either by the person actually looking into the device of the present invention or by a representative of the store applying the method of the present invention.

A store selling sunglasses using the method of the present invention has a clear competitive advantage over stores not doing so. Purchasers will appreciate the more rational method of purchase and the ability to pick the most suitable pair of glasses.

Additionally, use of the device can be used as a lever to convince purchasers to purchase more expensive sunglasses or even to purchase multiple pairs of sunglasses.

The present invention is not limited to the embodiment described herein but also relates to all kinds of modifications thereof, insofar as they are within the scope of the claims.

1. A method of testing glasses comprising
a. having a person view an image while wearing the glasses;
b. projecting light at eyes of said person; and
c. said person evaluating the efficacy of the glasses.

2. The method of claim 1 wherein attributes of said light projected at said eyes of said person are chosen so as to simulate specific lighting conditions.

3. The method of claim 2 wherein said specific lighting conditions simulated are chosen from a group consisting of outdoor, snow, ski slope, ocean, lake, beach, discotheque, dawn, dusk and desert lighting conditions.

4. The method of claim 1 wherein attributes of said light projected at said eyes of said person are varied.

5. The method of claim 1 wherein said attributes of said light include at least one of the attributes from a group consisting of spectrum, intensity, polarization, glare, diffusness and symmetry.

6. A device for testing glasses comprising:
a. an enclosure;
b. an image-displaying device located within said enclosure;
c. a view port in said enclosure through which an image, displayed using said image-displaying device, can be viewed; and
d. a light source configured to project light in the direction of said view port wherein said enclosure is so configured that the eyes of a person viewing said image through said view port are illuminated substantially only with light from said light source and from said image.

7. The device of claim 6 wherein said light source is not symmetrical.

8. The device of claim 6 wherein said light source is a variable light source.

9. The device of claim 8 further comprising a control unit configured to control variation of attributes of light produced by said variable light source.

10. The device of claim 6 wherein light illuminating the eyes of said person impinges the eyes from a plurality of directions.

11. The device of claim 6 wherein said light source is configured so as to illuminate the eyes of said person from a horizontal arc greater than about 90°.

12. The device of claim 6 wherein said light source is configured so as to illuminate the eyes of said person from a horizontal arc greater than about 120°.

13. The device of claim 6 wherein said light source is configured so as to illuminate the eyes of said person from a horizontal arc greater than about 135°.

14. The device of claim 6 wherein said light source is configured so as to illuminate the eyes of said person from a vertical arc greater than about 90°.

15. The device of claim 6 wherein said light source is configured so as to illuminate the eyes of said person from a vertical arc greater than about 100°.

16. The device of claim 6 wherein said light source is configured so as to illuminate the eyes of said person from a vertical arc greater than about 120°.

17. The device of claim 6 wherein said light source is configured so as to illuminate substantially the entire field of view of said person.

18. A method of selling glasses comprising
a. having a purchaser wear a pair of glasses to be purchased; and
b. evaluating the performance of said pair of glasses for said purchaser under at least one lighting condition by projecting at said purchaser light simulating said at least one lighting condition.

19. The method of claim 18 wherein at least one of said at least one lighting condition is selected from a group consisting of outdoor, snow, ski slope, ocean, lake, beach, discotheque, dawn, dusk and desert.
